(19) United States
(12) Patent Application Publication
(10) Pub. No.: US 2025/0353081 A1
(43) Pub. Date: Nov. 20, 2025

(54) COATER, FILLING DEVICE, SYSTEM FOR APPLYING MATERIAL LAYERS AND METHOD FOR ADDITIVE MANUFACTURING OF A WORKPIECE

(71) Applicant: DMG MORI ADDITIVE GMBH, Bielefeld (DE)

(72) Inventors: Guido ADAM, Paderborn (DE); Roman-Max MÖHLEN, Paderborn (DE)

(21) Appl. No.: 18/872,253

(22) PCT Filed: Nov. 28, 2022
(86) PCT No.: PCT/EP2022/083444

§ 371 Date: Dec. 5, 2024

(30) Foreign Application Priority Data
Jun. 8, 2022 (DE) 10 2022 114 418.6

(51) Int. Cl. B22F 12/57; B22F 10/28; B22F 12/63; B33Y 10/00; B33Y 30/00; B33Y 40/00

(52) U.S. Cl. CPC B22F 12/57; B22F 12/63; B22F 10/28; B33Y 10/00; B33Y 30/00; B33Y 40/00

(57) ABSTRACT

The invention provides a coater for applying material layers to a carrier of a machine tool, which is configured to layer-wisely build up a workpiece from the applied material layers, wherein the coater comprises a base body, which is movable relative to the carrier of the machine tool, a material storage chamber, which is carried by the base body and which has a filling chamber for storing material, and an application device which is configured to empty the filling chamber of the material storage chamber by a first relative motion of the filling chamber with respect to the base body in order to apply material stored in the filling chamber to the carrier.

### TECHNICAL FIELD

The present invention relates to a coater for applying material layers, a filling device for use with a coater, a system for applying material layers and a method for additive manufacturing of a workpiece.

### BACKGROUND OF THE INVENTION

In the state of the art, primary forming processes for additively manufacturing three-dimensional workpieces are known, during which a workpiece is built up layer by layer from a provided material.

For this purpose, a material layer of a powdery material is usually applied to a carrier of a machine tool and afterwards partially solidified into a workpiece layer by means of site-specific radiation, for example via fusing or sintering individual material particles of the material layer.

Once a workpiece layer has been solidified, a new layer of unprocessed material is applied to the support or to the already produced workpiece layer and site-specific irradiation is applied again.

In this way, the workpiece is successively built up layer by layer from material which is applied to the carrier in form of a plurality of material layers.

This process usually involves coaters spreading out a certain quantity of unprocessed material on the carrier to apply a material layer of predetermined thickness.

In the prior art, known coaters are moved relatively to the carrier of the machine tool in order to spread a quantity of material placed on the carrier via a spreading element in a layer-forming manner, wherein the spreading element can for example be brush- or lip-like. Such coaters are shown, for example, in DE 20 2019 103 407 U1 or EP 2 818 305 A1.

In order to increase efficiency during production, attempts are made to reduce the number of travel paths of the coater in such a way that, after applying a first material layer, the coater does not necessarily have to be moved back to a starting or refilling position at a stationary material reservoir before a further material layer can be applied.

For this purpose, solutions are known from DE 20 2019 103 407 U1 or EP 2 818 305 A1, in which the coater comprises a material storage with a filling chamber in which a quantity of material is carried along and, if required, is applied onto the carrier by actuating a closing mechanism for opening and closing a lower discharge opening of the filling chamber. Subsequently, the applied material can be spread out in a layer-forming manner, in particular during a movement of the coater, which is travelling back to said starting position, in which the material storage can be refilled for the next cycle.

However, when actuating said closing mechanism, inter alia a loss of function with incomplete opening and/or closing of the discharge opening as well as problems with uncontrolled or incomplete application of the stored material onto the carrier might be expected. As a result, the material layers are not applied onto the carrier as desired, which in turn has a negative effect on the production quality of the workpiece to be built up.

### SUMMARY OF THE INVENTION

Accordingly, it is a task of the invention to provide an improved possibility for a reliable and controlled application of material layers for additive manufacturing of workpieces.

To solve this task, a coater according to claim 1, a filling device according to claim 11 and a system for applying material layers according to claim 15 are provided.

A further task of the invention is to provide an improved possibility for additive manufacturing of workpieces.

To solve this further task, a method according to claim 16 is provided.

The respective dependent claims refer to preferred embodiments, each of which can be provided individually or in combination.

According to a first aspect of the invention, a coater is provided for applying material layers to a carrier of a machine tool, which is configured to layer-wisely build up a workpiece from the applied material layers. For this purpose, the coater comprises a base body, which is movable relative to the carrier of the machine tool, a material storage, which is carried by the base body and which has a filling chamber for storing material, and an application device which is configured to empty the filling chamber of the material storage device by a first relative motion of the filling chamber with respect to the base body in order to apply material stored in the filling chamber to the carrier.

The coater according to the first aspect provides a particularly efficient way of applying material layers to the carrier, from which a workpiece is layer-wisely built up in the course of an additive manufacturing process, in particular, by selective melting or sintering the applied material layers, for example by means of a laser beam-based processing device of the machine tool in the course of an SLM process (Selective Laser Melting).

The material to be applied is usually in powder form and preferably comprises metallic materials, such as aluminium-, steel-, titanium-, nickel-based alloy or any other alloy suitable for use in an SLM process.

While referring to the carrier, for example in the course of applying the material to the carrier as well as applying a material layer to the carrier, shall also include all material layers and/or solidified workpiece layers already applied to the carrier beforehand. Thus, also the cases in which a further material layer is formed on a material layer and/or on a workpiece layer already present on the carrier shall be included.

In order to reduce a distance that the coater has to travel per material layer to be applied, the coater advantageously carries along a quantity of material in the material storage in order to apply it to the carrier if required and to apply a new material layer to the carrier. In this way, the coater does not always have to return to its starting position at a stationary material dispenser, which itself applies a quantity of material to the carrier.

The coater thereby offers the particularly advantageous possibility of completely emptying the stored material in the course of the first relative motion, during which the filling chamber is moved in its entirety. Thereby, a particularly wear-free operation of the coater is implemented, as well as a particularly reliable and always complete emptying of the material stored in the material storage.

Therefore, the coater does not need any additional closing mechanisms for opening and closing an outlet opening of the filling chamber. Such closure mechanisms are for example known from DE 20 2019 103 407 U1 or EP 2 818 305 A1 which use a movably mounted closure element to close and open an opening of the filling chamber facing the carrier.

These closure mechanisms are exposed to increased loads due to the constant contact with the material, which is usually in powder form, which can deposit in bearing points, guide joints, fits, etc. of the movable closure mechanisms and impair their function. Such deposits are thereby favoured by vibrations inevitably occurring during the coater's movement.

This can lead to increased wear of the closure mechanism, as well as—under certain circumstances—also to a blocking of the closure mechanism. As a result, the opening of the filling chamber can no longer be opened or closed as intended, which in turn leads to uncontrolled dispensing of the material contained therein.

By implementing the emptying of the filling chamber via the first relative motion, such closure mechanisms can be omitted, so that the stored material essentially has or makes no contact with bearing points or guides of the coater, which could be negatively affected otherwise. This ensures functionality and particularly an operation with low wear.

The first relative motion also ensures that the filling chamber is completely emptied, as the filling chamber moves in its entirety. By this a flow limit of the usually powdery material can be exceeded more easily than in case of a filling chamber that is essentially stationary and in which only an opening on the lower side is opened/released by a closure mechanism. In this case, there is a risk that the material in the filling chamber will be “wedged” or “jammed”, such that so-called bridging occurs and the material does not move or does not begin to flow.

On the other hand, a motion of the filling chamber itself applies additional dynamic forces to the material, as a result of which even materials with a low flowability, especially powdery materials, can be dispensed in a reliable and complete manner.

In a preferred embodiment, the application device the application device comprises a rotatable support, via which the material storage is supported so as to be rotatable relatively to the base body about an axis of rotation, such that the first relative motion for emptying the filling chamber is a rotation about the axis of rotation.

In this way, a particularly effective way of emptying the filling chamber is provided, in the course of which it can be moved, for example from an initial position (with an opening usually pointing upwards in the vertical direction) to an overhead position (rotated 180°, with the opening usually pointing downwards in the vertical direction). As a result, material filled through an opening in the filling chamber is removed from the filling chamber and applied to the carrier via the same opening by means of gravitational force. By completely “tilting” the filling chamber relative to the base body into an overhead position, all material stored in the filling chamber can be reliably applied without any residual material remaining in the filling chamber.

Preferably, the axis of rotation runs parallel to a surface of the carrier and orthogonal to a travel direction of the base body.

The application device is thereby preferably configured to rotate the filling chamber by a predetermined angle from an initial position, in which the filling chamber is filled, into an end position, wherein the predetermined angle is preferably 90° to 270° and particularly preferably 180°.

Preferably, the angular position of the filling chamber relative to the base body of the coater is indicated on the basis of a zenith angle between a reference line of the filling chamber fixed to the filling chamber and a perpendicular direction directed against the gravitational field of earth. In a cross-section, the reference line runs perpendicular to the axis of rotation starting from a centre point of the filling chamber through the opening of the filling chamber. The zenith angle in the initial position of the filling chamber is preferably 0° and in the end position of the filling chamber is between 90° and 180°, particularly preferably 180°.

In a preferred embodiment, the coater comprises a spreading element attached to the base body, which is configured to spread a quantity of material placed on the carrier in a layer-forming manner by a movement of the base body.

In this way, a particularly uniform application of the material layers to the carrier can be implemented by spreading a quantity of material, which is for example placed as an accumulation on an end side on the surface of the carrier, over the carrier via the spreading element.

Spreading is primarily understood to sweep out the material, in the course of which the spreading element pushes the accumulated material in front of itself during a movement of the base body, while conveying the material through a gap of predetermined size between the spreading element and the carrier, and thus, spreading it in a layer-forming manner.

In a preferred embodiment, the base body can be moved back and forth relative to the carrier between a first and a second end position, in particular in a translatory manner, wherein the coater is configured to spread a first quantity of material on the carrier via the spreading element in a layer-forming manner by a first movement of the base body from the first to the second end position and, and is further configured to empty the filling chamber of the material storage by the first relative motion in order to apply the second quantity of material to the carrier as the second end position or an application position, which is located between the first and the second end position, is reached.

Preferably, the coater is configured to spread the second quantity of material, which was applied to the carrier when the second end position or the application position was reached, via the spreading element by a second movement of the base body from the second to the first end position in a layer-forming manner.

In this way, unnecessary movements of the coater are avoided and two material layers can be applied in one cycle from the first to the second end position and back again. The advantageous design of the application device allows a controlled application of the material for forming a second material layer without residues of the material remaining in the filling chamber, so that material layers of constant quality can be applied to the carrier.

In a preferred embodiment, the application device comprises a drive unit connected to the material storage, in particular an electric drive unit, which is configured to cause the first relative motion of the filling chamber.

In a preferred alternative embodiment, the application device comprises an actuating element connected to the material storage, the actuation of which causes a relative motion of the filling chamber with respect to the base body.

The actuation is to be understood here as a mechanical interaction with force and/or torque transmission to the actuating element, which cause said relative motion of the filling chamber.

In this way, the application device is not dependent on an internal drive unit or the like, but can be actuated by interaction of the actuating element with other elements. This reduces costs and maintenance effort compared to the design with a drive unit.

In a preferred embodiment, the coater comprises a first contact element attached to the machine tool, in particular to the carrier, wherein the coater is configured to actuate the actuating element by a movement of the base body, in particular by the first movement of the base body, via interaction with the first contact element in such a way that this causes the first relative motion for emptying the filling chamber.

In this way, the actuation of the application device for emptying the filling chamber is advantageously initiated by travel movements of the coater itself as soon as the actuating element interacts with the first contact element. By that, otherwise necessary drive units within the coater can be omitted, reducing costs and installation space as well as maintenance effort.

Furthermore, the mechanical interaction represents a reliable “limit switch” that always causes the filling chamber to be emptied at the same position in the course of the base body's movement, which is, compared to an electronic limit switch, also safe against failure.

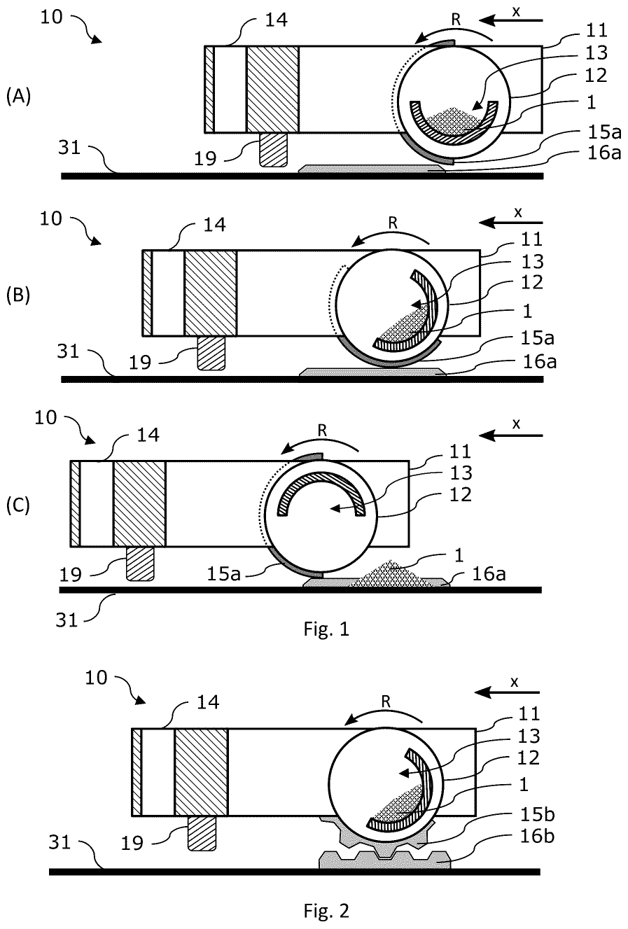

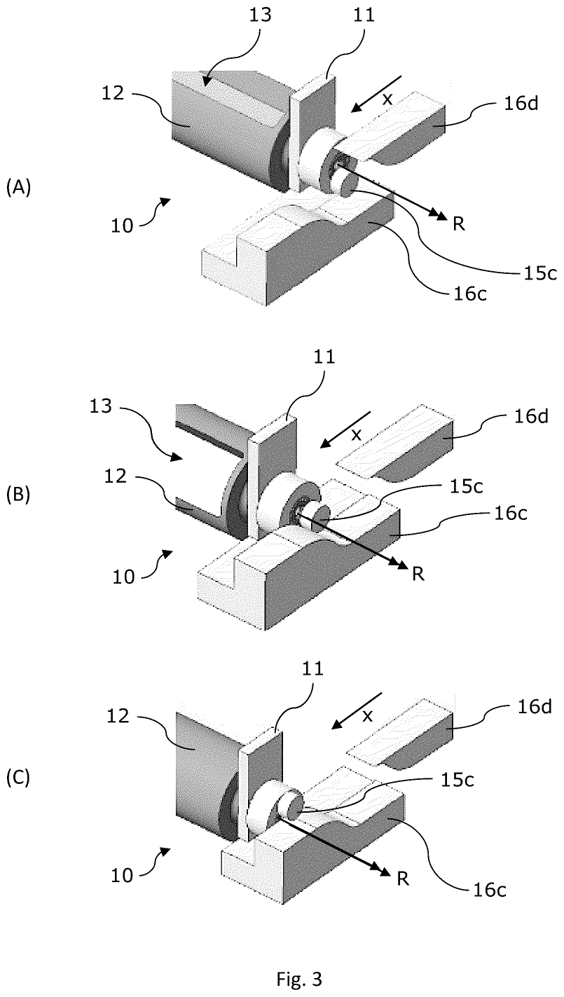

Examples for pairings of the actuating element and the first contact element are pairings of contact disc and rolling contact element (see FIG. 1), toothed wheel disc and toothed rack (see FIG. 2), eccentric crank and profile body (see FIG. 3) or any type of slide or slotted guide.

In a preferred embodiment, the coater comprises a second contact element attached to the machine tool, wherein the coater is configured to actuate the actuating element via contacting the second contact element by a movement of the base body in such a way that this causes a second relative motion of the filling chamber with respect to the base body, as a result of which the filling chamber is brought into an initial position suitable for refilling material to be stored in the filling chamber.

In this way, a thoroughly automated sequence of movements of the filling chamber is implemented, which only depends on the movements of the coater's base body.

In a preferred alternative embodiment, the coater comprises a restoring element connected to the material storage, which exerts a restoring force on the material storage to cause a second relative motion of the filling chamber with respect to the base body, as a result of which the filling chamber is brought into an initial position suitable for refilling material to be stored in the filling chamber.

In this way, after the first relative motion has taken place, the filling chamber can be returned to the initial position by the restoring force, which happens in particular when the actuating element no longer interacts with the first contact element.

According to a second aspect of the invention, a filling device is provided for filling a material storage of a coater, which is configured to apply material layers to a carrier of a machine tool and is thereby movable relative to the carrier, comprising a supply storage having a storage chamber for storing material and an outlet opening for discharging material stored in the storage chamber, and a dispensing device arranged on the supply storage, which is configured to be brought from a first position, in which the outlet opening is closed, into a second position, in which the outlet opening is opened, by a movement of the coater in such a way that material stored in the storage chamber is filled into the material storage of the coater via the outlet opening. In particular, the machine tool is configured to layer-wisely build up a workpiece from the material layers applied by the coater.

In this way, the movement of the coater itself acts as a trigger for filling or refilling its material storage, and thus, does not need any electronic limit switches or the like that initiate the filling, for example via a metering screw, as soon as the coater has reached its refilling position below the outlet opening of the supply storage.

Furthermore, no direct drive for relatively driving mechanical closure components of the supply storage is required, for example via an electric motor, as the actuating force required to operate the dispensing device is provided entirely by the coater itself.

Thus, the filling device is designed as a passive and essentially stationary device attached to the machine tool for interaction with the movable coater in order to cause the material storage thereof to be filled by means of said interaction.

The outlet opening remains closed without interaction with the coater, so that when the coater moves elsewhere, for example to apply a material layer, the storage chamber of the supply storage can be supplied with a further quantity of material for a subsequent filling process.

Preferably, the dispensing device comprises a restoring element which closes the outlet opening by applying a restoring force as soon as the coater no longer interacts with the filling device, for example as a result of a loss of contact when the coater moves out of its refilling position.

In a preferred embodiment, the dispensing device is designed as a sliding element which is movably mounted with respect to the supply storage and has a contact portion which is designed to come into contact with the coater in the course of the latter's movement and to displace the sliding element from the first position to the second position as the movement progresses.

In this way, a transmission-free interaction between the filling device or its dispensing device and the coater can be provided, whereby the actuation of the dispensing device takes place by establishing contact at the contact portion. Thus, when setting up the filling device on the machine tool, only an initial positioning of the contact section depending on the coater is required.

In order to be able to adapt to coaters of different dimensions, the sliding element preferably comprises adjustment means, for example a pull-out or the like, in order to be able to adapt the position of the contact portion relative to the supply storage to the refilling position of the coater.

As an alternative to the design as a sliding element, the dispensing device can also be designed as a tilting element, having a lever portion which is designed to come into contact with the coater as it moves and to tilt the tilting element from the first position to the second position as the movement progresses (in the sense of a rotation about a bearing point of the tilting element).

In a preferred embodiment, the filling device further comprises a material reservoir and a dosing device configured to fill the storage chamber of the supply storage with a predetermined quantity of material from the material reservoir.

This ensures that between individual filling processes, the storage chamber of the supply storage is always supplied with the required quantity of material to be filled into the coater.

In a preferred embodiment, the supply storage comprises a further storage chamber for material and a further outlet opening for discharging material stored in the further storage chamber, wherein the dispensing device is configured to also close the further outlet opening in the first position and to also release the further outlet opening in the second position.

In this way, the coater's material storage is filled as a result of the coater's movement, as well as a further quantity of material can also be simultaneously applied onto the carrier of the machine tool via the further outlet opening, which is then spread on the carrier in a layer-forming manner when the coater moves out of the refilling position.

Thus, a single movement of the coater at the filling device is advantageously utilised in such a way, that a first quantity of material is automatically applied onto the carrier and substantially simultaneously a second quantity of material is filled into the material storage of the coater, wherein a first material layer is applied from the first quantity and thereafter a second material layer is applied onto the carrier on the basis of the material stored in the material storage.

According to a third aspect of the invention, a system for applying material layers to a carrier of a machine tool is provided. The machine tool is configured to layer-wisely build up a workpiece from the applied material layers and comprises a coater according to one embodiment of the first aspect of the invention and a filling device according to one embodiment of the second aspect of the invention, configured to fill the material storage of the coater.

In this way, a system for depositing material layers by means of additive manufacturing is provided, which combines the abovementioned advantages of the coater according to the first aspect and the filling device according to the second aspect.

In particular in embodiments of the coater with actuating element, almost all actions, which move the material to be applied, are triggered or performed by movements of the coater relative to the carrier of the machine tool.

Thus, the system according to the third aspect does exemplary not require electronic limit switches to coordinate the actions of the individual components, resulting in a simple and entirely mechanical synchronisation of carrier, coater and filling device, which is safe against failure as well as cost-effective and requires low maintenance.

According to a fourth aspect of the invention, a method for additively manufacturing a workpiece with a machine tool is provided, said machine tool comprises at least a carrier and a coater for applying material layers on the carrier. In this case, the method comprises at least the steps of applying a quantity of material stored in a filling chamber of a material storage of the coater to the carrier of the machine tool, applying a material layer to the carrier by spreading the quantity of material applied from the filling chamber in a layer-forming manner by the coater, and building up a workpiece layer of the workpiece from parts of the applied material layer by melting or sintering, wherein applying the quantity of material stored in the filling chamber of the coater to the carrier comprises moving the filling chamber relative to a base body of the coater, which carries the material storage, for emptying the filling chamber.

Thus, the additive manufacturing process makes use of the advantages of the uniform, fast and reliable application of a material layer, as already described in connection with the inventive coater.

This allows efficient additive manufacturing of workpieces with low downtimes as well as a high manufacturing quality.

The material layers should usually be applied evenly from a predetermined quantity of material. However, due to the irregular and sometimes incomplete application via a closure mechanism, for example fluctuations in the quantity of the applied material occur, such that a material layer may not be applied completely, as too little material has been applied. In order to compensate for this problem in the case of using closure mechanisms, the material to be applied is usually overdosed beyond the predetermined quantity.

On the other hand, the use of the coater according to the invention allows complete emptying of the material stored in it due to the emptying by relative motion of the filling chamber, so that overdosing is no longer necessary and material can thus be saved in the course of applying the material layers.

Likewise, as described for the coater according to the invention, the mechanical components of the coater are only slightly loaded by the material to be applied, so that inaccuracies caused by wear when applying the material layers can also be reduced and a lifetime can be increased when using the coater by way of additive manufacturing.

Preferably, depositing the material layer to the carrier by spreading the quantity of material applied from the filling chamber in a layer-forming manner by the coater comprises moving the base body of the coater relative to the carrier of the machine tool.

Preferably, before applying the quantity of material stored in the filling chamber of the material storage, the method comprises applying a first quantity of material to the carrier of the machine tool and filling the filling chamber of the material storage of the coater with the quantity of material to be stored in the filling chamber.

In this way, the required quantities of material for two successive material layers are provided together in one refilling position of the coater.

Preferably, the method then comprises applying a first material layer to the carrier by spreading the first quantity of material applied to the carrier in a layer-forming manner, in particular by a first movement of the base body relative to the carrier, and building up a first workpiece layer of the workpiece to be produced from parts of the applied first material layer by melting or sintering.

In this way, the first material layer is applied via the coater while simultaneously carrying the required quantity of material for a subsequent application of the material layer that will be spread from the stored material in the filling chamber. This reduces the number of travels, and thus, also the production time. When the coater reaches its end position and has applied the first material layer, the first workpiece layer can be built up immediately without moving necessity to move the coater back to its starting position beforehand.

After the first workpiece layer has been built up, the stored quantity of material is discharged from the filling chamber, followed by the process steps described above.

Preferably, however, the application of the stored quantity of material can also take place simultaneously with the build-up of the first workpiece layer in order to further reduce process times during production.

Further aspects and advantages thereof as well as more specific embodiments of the aforementioned aspects and features are described below with the aid of the drawings shown in the accompanying figures.

FIGS. 1A to 1C show schematic cross-sectional views of a first embodiment of the coater according to the invention for different positions in the course of a movement of the base body.

FIG. 2 shows a schematic cross-section of a second embodiment of the coater according to the invention.

FIGS. 3A to 3C show a perspective view of a section of a third embodiment of the coater according to the invention for different positions in the course of a movement of the base body.

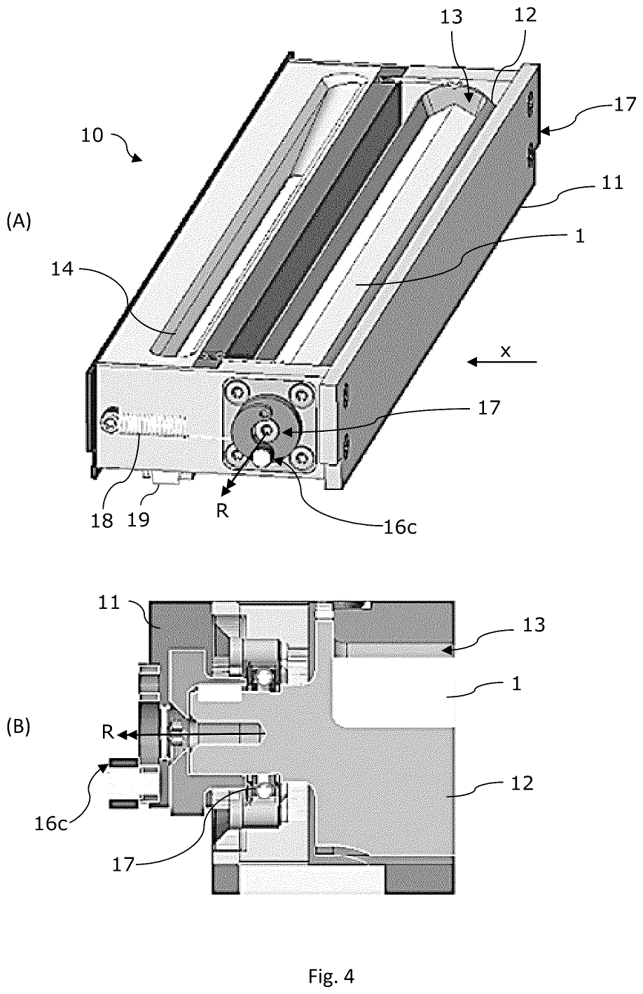

FIGS. 4A and 4B show views of a fourth embodiment of the coater according to the invention.

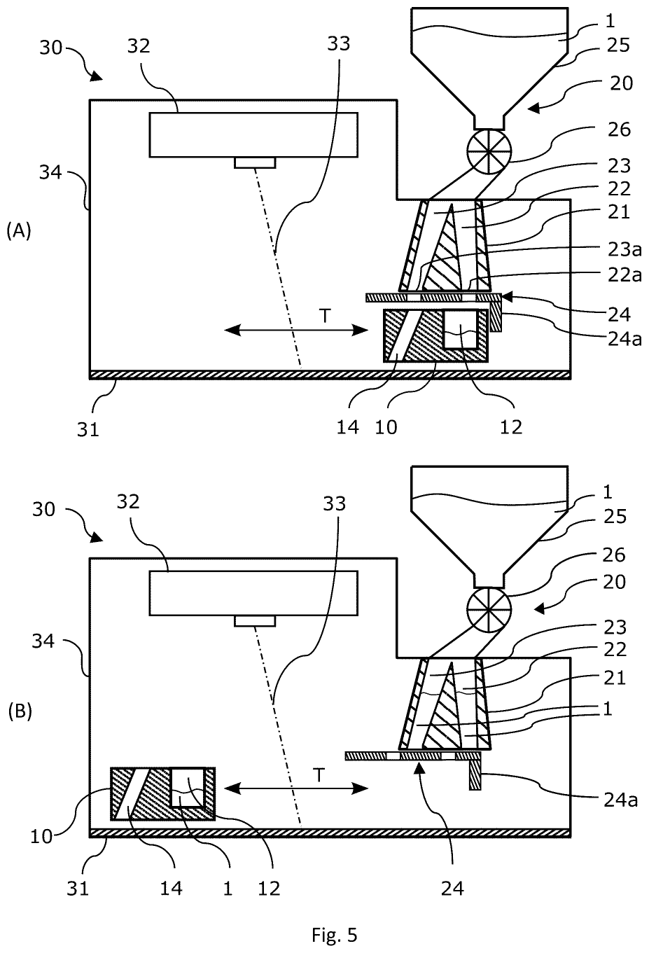

FIGS. 5A and 5B show schematic views of a machine tool with a coater and an embodiment of the filling device according to the invention in various states.

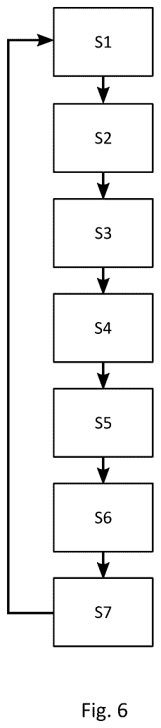

FIG. 6 shows a flowchart of an embodiment of the method according to the invention for additive manufacturing of a workpiece.

It is emphasised that the present invention is in no way limited to the examples of embodiments and their features described below. The invention further encompasses modifications of said embodiments, in particular those resulting from modifications and/or combinations of individual or multiple features of the described embodiments within the scope of protection of the independent claims.

### DETAILED DESCRIPTION OF THE FIGURES

FIGS. 1A to 1C show schematic cross-sectional views of a first embodiment of the coater 10 according to the invention for different positions in the course of a movement of a base body 11 of the coater 10.

The shown coater 10 comprises the base body 11 and a material storage 12, carried by the latter, for material 1 which is to be applied by the coater 10 in the form of a material layer to a carrier 31 of a machine tool, in order to build up a workpiece layer of a workpiece therefrom by way of additive manufacturing.

In the embodiment shown, the carrier 31 is plate-shaped, whereby the base body 11 of the coater 10 is movable relative to the carrier 31 of the machine tool.

In the embodiment shown, the base body 11 is translatable back and forth between a first and a second end position with respect to the carrier 31 along the x-direction shown, the x-direction thereby running parallel to a surface of the plate-shaped carrier 31.

The coater comprises on its lower side a spreading element 19 which faces the carrier 31, which can exemplary be designed as a coater brush, coater lip or coater blade, and is set up for the layer-forming spreading of a quantity of material 1 located on the carrier 31 in the course of a movement of the base body 11 between the first and the second end position (and vice versa).

In the embodiment shown, the material storage 12 is cylindrical and comprises a filling chamber 13 with a semi-circular cross-section and an opening at the top in an initial position (see FIG. 1A), through which material 1 to be stored can be filled into the filling chamber 13 of the material storage 12. The material storage 12 with filling chamber 13 allows material 1 to be stored and carried along in the course of a movement of the base body 11.

In this way, during a first layer-forming spreading of a first quantity of material 1 on the carrier 31 by the spreading element 19 during a first movement from the first to the second end position along the x-direction, a second quantity of material 1 can already be carried along for a second layer-forming spreading in the course of a subsequent second movement against the drawn x-direction from the second end position back to the first end position.

When the base body 11 reaches its end position relative to the carrier 31 at the end of the first movement, the coater 10 is configured to apply the quantity of material 1 stored in the filling chamber 13 onto the carrier 31, as shown in the chronological sequence in FIGS. 1A to 1C.

For this purpose, the coater 10 comprises an application device which, in the present case, comprises a rotatable support of the material storage 12 and which is set up to empty the filling chamber 13 of the material storage 12 by a rotational relative motion of the filling chamber 13 with respect to the base body 11 (about the axis of rotation R).

To initiate the rotational relative motion, the application device comprises an actuating element connected to the material storage, which is designed as a semi-circular contact disc 15a in this case.

The contact disc 15a is not limited to a semi-circular shape, but can be designed as any partial or full circle in the cross-section shown. A rotation of the contact disc 15a is thereby transmitted to the material storage 12 and causes the rotational relative motion of the filling chamber 13.

The coater 10 further comprises a first contact element attached to the carrier 31, which is designed as a rolling contact element 16a in the present case. The coater 10 is configured in such a way that the movement of the base body 11 along the x-direction causes the contact disc 15a to interact with the rolling contact element 16a in such a way that the rotational relative motion for emptying the filling chamber 13 is caused.

Starting from the position in FIG. 1A, as the movement of the base body progresses, contact is made (see FIG. 1B) between the contact disc 15a and the rolling contact element 16a, as a result of which the contact disc 15a rolls on the rolling contact element, the rotation of the contact disc 15a is transmitted to the material storage 12 and its filling chamber 13, which is then rotated from its initial position relative to the base body 11 depending on the rolling of the contact disc 15a.

The rotation causes a change in the position of the filling chamber 13 and in particular its opening relative to the base body 11, whereby the powdery material 1 begins to flow relative to the filling chamber 13 with proceeding rotation and moves towards the opening of the filling chamber 13 so as to pass through onto the carrier 31. The relative motion ends in the position shown in FIG. 1C, in which the filling chamber 13 has been completely emptied.

The powdery material 1 does not come into contact with mechanical components of the coater 10, such as bearing points, guide joints and the like, which inter alia reduces wears and increases lifetime.

Similarly, moving the filling chamber 13 itself, exemplary ending in the overhead position of the filling chamber 13 shown in FIG. 1C, ensures that it is completely emptied without any residual material remaining in it.

As shown in FIG. 1C, the quantity of material 1 has been applied to the carrier from the filling chamber 13 of the material storage and can be spread onto the carrier 31 in a layer-forming manner by the spreading element 19 in a second movement of the base body 11 against the x-direction.

Furthermore, the coater 10 also comprises a channel 14 on the left side in the cross-sections shown, which extends from an upper side of the base body 11 to a lower side facing the carrier 31. The channel 14 serves to feed material 1 directly onto the carrier 31 in interaction with a filling device not shown here, which is configured to fill material into the filling chamber 13 of the material storage 12 as well as to apply it directly to the carrier 31 through the channel 14, in particular in order to spread the latter in a layer-forming manner in the course of the first movement, while a further quantity of material 1 is carried along in the filling chamber 13.

FIG. 2 shows a schematic cross-sectional view of a second embodiment of the coater according to the invention.

The design of the coater 10 corresponds to that of the first embodiment from FIGS. 1A to 1C, except for the design of the actuating element of the application device and the first contact element, so that no further description is provided here.

The actuating element of the second embodiment is designed as a toothed wheel 15b, which interacts with a toothed rack 16b attached to the carrier 31, as a first contact element, in order to cause the rotational relative motion of the filling chamber 13 on basis of a toothed mechanism.

Compared to the version with contact wheel 15a and rolling contact element 16a from FIG. 1, the present version is more expensive, but there is no problem of slippage when rolling the contact wheel 15a, so that the rotational relative motion can be controlled better.

In both, the first and the second embodiment, the first contact element-rolling contact element 16a or toothed rack 16b—is at the same time a second contact element, which interacts with the actuating element—contact disc 15a or toothed wheel disc 15b—in the course of the second movement of the base body 11, in order to return the filling chamber 13 to its initial position by way of a second relative motion, so that the filling chamber 13 can be filled again with material 1 to be stored.

Another possibility for initiating the relative motion of the filling chamber 13 is shown in FIGS. 3A to 3C, which show perspective views of a section of a third embodiment of the coater 10 according to the invention for different positions in the course of a movement of the base body 11.

The shown coater 10 comprises the base body 11, which is only partially shown, and a material storage 12, which is carried by the base body 11, for storing material to be applied by the coater 10 in the form of a material layer to a carrier of a machine tool, which is not shown here, in order to build up a workpiece layer of a workpiece by means of additive manufacturing.

The base body 11 of the coater 10 can be moved relative to the carrier of the machine tool. In the example shown, the base body 11 can be moved translational back and forth along the x-direction shown.

In the embodiment shown, the material storage 12 is cylindrical and comprises a groove-shaped recess incorporated into the cylindrical geometry as a filling chamber 13 with an opening on the cylinder wall side, through which material to be stored can be filled into the filling chamber 13 of the material storage 12.

The coater 10 comprises an application device arranged laterally to the material storage 12, which comprises a rotatable support of the material storage 12 with respect to the shown section of the base body 11 in the present case.

Said support can be designed, for example, as a roller or plain bearing. The application device is configured to empty the filling chamber 13 of the material storage 12 by a rotational motion of the filling chamber 13 relative to the base body 11 about the axis of rotation R (refer to the positions of the filling chamber 12 in FIG. 3A and FIG. 3B).

To initiate the rotational relative motion, the application device comprises an actuating element connected to the material storage 12, which is designed as an eccentric crank 15c. The eccentric crank 15c comprises a pin, positioned eccentrically with respect to the axis of rotation R of the material storage 12, which is configured to interact with contact elements 16c, 16d on the side of the machine tool, in order to cause the rotational relative motion of the filling chamber 13.

For this purpose, the coater 10 comprises a first contact element attached to the machine tool, which is designed as a profiled body 16c with a curved guide surface along which the pin of the eccentric crank 15c is guided in the course of the first movement along the x-direction after contact has been made (see FIG. 1B), in such a way that this causes a rotation of the eccentric crank 15c, which is transmitted to the material storage 12 and causes the relative motion for emptying the filling chamber 13.

After reaching the end position (see FIG. 3C), the emptied filling chamber 12 can be returned to its initial position by interaction with a second contact element attached to the machine tool. Similar to the first contact element, the second contact element is also designed as a second profile body 16d with a curved guide surface along which the pin of the eccentric crank 15c is guided in the course of the second movement against the x-direction after contact has been made, in such a way that this causes a rotation of the eccentric crank 15c, which is transferred to the material storage 12 and brings the filling chamber 13 into its initial position.

FIGS. 4A and 4B show a fourth embodiment of the coater according to the invention in a perspective view (FIG. 4A) and in an enlarged cross-sectional view (FIG. 4B).

The shown coater 10 comprises a frame-shaped base body 11, which carries in a first recess a material storage 12 for storing material to be applied by the coater 10 in the form of a material layer to a carrier of a machine tool (not shown here), in order to build up a workpiece layer of a workpiece therefrom by additive manufacturing.

The base body 11 of the coater 10 can be moved relative to the carrier of the machine tool. In the example shown, the base body 11 can be moved translational back and forth along the x-direction shown.

The coater comprises a spreading element 19 on the lower side facing the carrier, which is designed as a coater lip in this case and is set up for the layer-forming spreading of a quantity of material 1 located on the carrier in the course of a movement of the base body 11.

In the embodiment shown, the material storage 12 is designed as a trough shaft whose trough-shaped recess functions as a filling chamber 13 for the material.

The coater 10 comprises an application device, which comprises a rotatable support of the material storage 12 with respect to the base body 11, each with lateral bearing points 17. FIG. 4B shows an enlarged cross-sectional view in the area of the front bearing point 17 from FIG. 4A, which shows an implementation of the rotatable support via a ball bearing.

The application device is configured to empty the filling chamber 13 of the material storage 12 by a rotational relative motion of the filling chamber 13 with respect to the base body 11 about the axis of rotation R.

To initiate the rotational relative motion, the application device comprises an actuating element connected to the material storage 12, which is designed as an eccentric crank 15c in the present case, similar to the embodiment shown in FIG. 3.

The eccentric crank 15c comprises a pin positioned eccentrically with respect to the axis of rotation R of the material storage 12, which is configured to interact with contact elements on the side of the machine tool (not shown here), in order to cause the rotational relative motion of the filling chamber 13 (see also FIGS. 3A to 3C). The eccentric crank 15c is screwed to one end face of the material storage device 12, which is designed as a trough shaft, so that a rotation of the eccentric crank 15c is transmitted to the trough shaft.

Furthermore, the coater comprises an elastic return element 18 designed as a spiral spring, which is connected to the material storage 12 via the eccentric crank 15c. A connection point is eccentric to the axis of rotation R, so that the restoring force applied by the restoring element 18 applies a restoring torque to the material storage 12, in order to bring it back into an initial position (corresponding to the position shown in FIG. 4A), which is suitable for filling the filling chamber 13.

FIGS. 5A and 5B show schematic views of a machine tool 30 with a coater 10 and an embodiment of the filling device 20 according to the invention in various states.

FIG. 5A shows a state with the coater 10 being in a refilling position, whereas FIG. 5B shows a state with the coater 10 being in an end position opposite to the refilling position.

The machine tool comprises a carrier 31, a processing device 32 arranged for optically irradiating material layers on the carrier with a laser beam 33, and a housing 34 defining a process space of the machine tool 30.

Further, the machine tool 30 comprises a coater 10 and a filling device 20 for filling a material storage 12 of the coater 10.

The coater 10 shown in FIGS. 5A and 5B may be a coater according to the first aspect of the invention, but should not be limited thereto as long as the coater 10 comprises a material storage 12 having a filling chamber which may be filled by the filling device 20 so that material 1 stored therein may be carried along during a movement of the coater 10, in this case translationally along the direction T.

The coater 10 comprises a through channel 14 for passing material 1 directly from an upper side opening to a lower side opening facing the carrier 31.

The filling device 20 comprises a supply storage 21 with a storage chamber 22 for storing material 1 and an outlet opening 22a for discharging material 1 stored in the storage chamber 22, and a dispensing device which is arranged on the supply storage 21, and which is designed as a sliding element 24, and is arranged to be displaced by a movement of the coater 10 from a first position, in which the outlet opening 22a (see FIG. 5B) is closed into a second position (see FIG. 5A), in which the outlet opening 22a is opened, in such a way that material 1 stored in the storage chamber 22 is filled into the material storage 12 of the coater 10 via the outlet opening 22a.

The sliding element 24 has a contact portion 24a oriented orthogonally to the travel direction T, which is designed to come into contact with the contact section 24a in the course of the movement of the coater 10 and to displace the sliding element 24 from the first position to the second position as the movement progresses, in this case, as the coater 10 moves from left to right, in the course of which the outlet opening 22a is released.

In this way, when the coater 10 moves into the refilling position (see FIG. 5A), the material storage 12 is filled without additional drive units or the like, but merely on basis of the displacement of the sliding element 24 caused by the coater 10 itself, which is mounted on the lower side of the supply storage 21 so as to be displaceable parallel to the travel direction T.

Thus, the filling device 20 is arranged as a passive and substantially stationary device mounted on the machine tool 30 for interaction with the moving coater 10 to cause filling of the material storage 12 thereof by said interaction.

In addition, the filling device 20 further comprises a further storage chamber 23 with an associated further outlet opening 23a, which can also be opened and closed by the sliding element 24, preferably together with the other outlet opening 22a.

The material 1 discharged through the outlet opening 23a passes through the through channel 14 of the coater 10 directly onto the carrier 31 and can be spread in the course of a movement from the refilling position shown in FIG. 5A to the end position shown in FIG. 5B in a layer-forming manner.

Furthermore, the filling device 20 comprises a dosing device 26 arranged at a top opening of the supply storage 21, which is designed as a rotary valve in the present case, via which material 1 can be filled from a material reservoir 25 into the storage chambers 22, 23 after the storage chambers 22, 23 have been emptied by actuation of the sliding element 24 by the coater 10.

In this way, another filling process of the material storage 12 or another discharge of material through the through channel 14 of the coater 10 onto the carrier 31 can take place.

FIG. 6 shows a flow chart of an embodiment of the method according to the invention with steps S1 to S7 for additive manufacturing of a workpiece with a machine tool, which comprises at least a carrier and a coater for applying material layers to the carrier.

In step S1, a first quantity of material is applied onto the carrier of the machine tool.

In step S2, a filling chamber of a material storage of the coater is filled with a second quantity of material to be stored in the filling chamber.

In step S3, a material layer is applied to the carrier by spreading the first quantity of material applied to the carrier in a layer-forming manner, in particular by a first movement of a base body of the coater relative to the carrier.

In step S4, a workpiece layer of the workpiece to be produced is built up from parts of the applied material layer by melting or sintering, in particular with the aid of a laser-based processing device of the machine tool.

In step S5, the second quantity of material stored in the filling chamber is applied onto the carrier of the machine tool by moving the filling chamber relatively to the base body of the coater, which carries the material storage, to empty the filling chamber.

In step S6, a further material layer is applied to the carrier by spreading the second quantity of material applied to the carrier in a layer-forming manner, in particular by a second movement of the coater relative to the carrier.

In step S7, a further workpiece layer of the workpiece to be produced is built up from parts of the applied further material layer by melting or sintering, in particular with the aid of a laser-based processing device of the machine tool.

Subsequently, steps S1 to S7 are repeated as often as required in order to build up a large number of workpiece layers until the desired workpiece has been produced.

### LIST OF REFERENCE SIGNS

1 material
10 coater
11 base body
12 material storage
13 filling chamber
14 through duct
15a contact disc
15b Gear wheel
15c eccentric crank
16a rolling contact element
16b rack
16c profile body
16d second profile body
17 bearing point
18 restoring element
19 spreading element
20 filling device
21 supply storage
22 storage chamber
22a outlet opening
23 further storage chamber
23a further outlet opening
24 sliding element
24a contact portion
25 material reservoir
26 dosing device
30 machine tool
31 carrier
32 machining device
33 laser beam
34 housing

The invention claimed is:

1-16. (canceled)

17. A coater for applying material layers to a carrier of a machine tool, which is configured to layer-wisely build up a workpiece from the applied material layers, comprising:
a base body, which is movable relative to the carrier of the machine tool;
a material storage, which is carried by the base body, with a filling chamber for storing material; and
an application device, which is configured to empty the filling chamber of the material storage via a first relative motion of the filling chamber with respect to the base body in order to apply material stored in the filling chamber to the carrier.

18. The coater according to claim 17, wherein
the application device comprises a rotatable support, via which the material storage is supported so as to be rotatable relatively to the base body about an axis of rotation, such that the first relative motion for emptying the filling chamber is a rotation about the axis of rotation.

19. The coater according to claim 17, wherein
the coater comprises a spreading element attached to the base body, which is configured to spread a quantity of material placed on the carrier in a layer-forming manner by a movement of the base body.

20. The coater according to claim 19, wherein
the base body is movable relative to the carrier between a first and a second end position,
wherein the coater is configured to spread a first quantity of material on the carrier via the spreading element by a first movement of the base body from the first to the second end position in a layer-forming manner while carrying along a second quantity of material in the material storage,
and is further configured to empty the filling chamber of the material storage by the first relative motion in order to apply the second quantity of material to the carrier as the second end position or an application position, which is located between the first and the second end position, is reached.

21. The coater according to claim 20, wherein
the coater is configured to spread the second quantity of material, which was applied to the carrier when the second end position or the application position was reached, via the spreading element by a second movement of the base body from the second to the first end position in a layer-forming manner.

22. The coater according to claim 17, wherein
the application device comprises a drive unit connected to the material storage, which is configured to cause the first relative motion of the filling chamber with respect to the base body.

23. The coater according to claim 17, wherein
the application device comprises an actuating element connected to the material storage, the actuation of which causes a relative motion of the filling chamber with respect to the base body.

24. The coater according to claim 23, wherein
the coater comprises a first contact element attached to the machine tool,
wherein the coater is configured to actuate the actuating element by a movement of the base body via an interaction with the first contact element in such a way that this causes the first relative motion for emptying the filling chamber.

25. The coater according to claim 23, wherein
the coater comprises a second contact element attached to the machine tool,
wherein the coater is configured to actuate the actuating element via contacting the second contact element by a movement of the base body in such a way that this causes a second relative motion of the filling chamber with respect to the base body, as a result of which the filling chamber is brought into an initial position suitable for refilling material to be stored in the filling chamber.

26. The coater according to claim 17, wherein
the coater comprises a restoring element connected to the material storage which exerts a restoring force on the material storage in order to cause a second relative motion of the filling chamber with respect to the base body, as a result of which the filling chamber is brought into an initial position suitable for refilling material to be stored in the filling chamber.

27. A filling device for filling a material storage of a coater, which is configured to apply material layers to a carrier of a machine tool and which is therein movable relative to the carrier, comprising:
a supply storage having a storage chamber for storing material and an outlet opening for discharging material stored in the storage chamber; and
a dispensing device arranged at the supply storage, which is configured to be brought from a first position, in which the outlet opening is closed, into a second position, in which the outlet opening is opened, by a movement of the coater in such a way that material stored in the storage chamber is filled into the material storage of the coater via the outlet opening.

28. The filling device according to claim 27, wherein
the dispensing device is designed as a sliding element which is movably mounted with respect to the supply storage and which has a contact portion which is designed so as to come into contact with the coater in the course of the latter's movement and to displace the sliding element from the first position to the second position as the movement progresses.

29. The filling device according to claim 27, wherein
the filling device further comprises a material reservoir and a dosing device, which is configured to fill the storage chamber of the supply storage with a predetermined quantity of material from the material reservoir.

30. The filling device according to claim 27, wherein
the supply storage comprises a further storage chamber for material and a further outlet opening for discharging material stored in the further storage chamber,
wherein the dispensing device is configured to also close the further outlet opening in the first position and to also release the further outlet opening in the second position.

31. The filling device according to claim 27, which is combined with a coater to form a system for applying material layers to a carrier of a machine tool, which is configure to layer-wisely build up a workpiece from the applied material layers, wherein
the coater comprises:
a base body, which is movable relative to the carrier of the machine tool;
a material storage, which is carried by the base body, with a filling chamber for storing material; and
an application device, which is configured to empty the filling chamber of the material storage via a first relative motion of the filling chamber with respect to the base body in order to apply material stored in the filling chamber to the carrier.

32. A method for additively manufacturing a workpiece with a machine tool, which comprises at least one carrier and a coater for applying material layers to the carrier, at least comprising the steps of:
applying a quantity of material stored in a filling chamber of a material storage of the coater to the carrier of the machine tool;
applying a material layer to the carrier by spreading the quantity of material applied from the filling chamber in a layer-forming manner by the coater; and
building up a workpiece layer of the workpiece from parts of the applied material layer by melting or sintering; wherein
the applying the quantity of material stored in the filling chamber of the material storage of the coater to the carrier comprises:
moving the filling chamber relative to a base body of the coater, which carries the material storage, for emptying the filling chamber.
